(19) United States
(12) Patent Application Publication
(10) Pub. No.: US 2005/0289087 A1
(43) Pub. Date: Dec. 29, 2005

(54) Shipping rate calculator and comparator

(76) Inventors: Steven R. Dixel, Arlington, VA (US); Catherine E. Moriarity, Ellicott City, MD (US); Charlotte Wilson, Falls Church, VA (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/952,812

(22) Filed: Sep. 30, 2004

Related U.S. Application Data
(60) Provisional application No. 60/583,470, filed on Jun. 28, 2004.

(30) Foreign Application Priority Data
Sep. 30, 2004 (WO) PCT/US04/32199

(51) Int. Cl. G06F 17/00

(52) U.S. Cl. 705/402

(57) ABSTRACT

A system and method for calculating and comparing costs to ship a shipment to a selected location by several shippers, including U.S. Postal Service and various commercial shipping companies. The user inputs into the calculator and comparator, background information, including number of packages, average weight per package, and destination zone, and also inputs customer discount (if any) from the commercial shipper. The calculator and comparator uses preprogrammed rate tables to calculate a base rate for U.S. Postal Service and for the commercial shipper being compared. The calculator and comparator also uses preprogrammed surcharge rates to calculate total surcharges for the commercial shipper. The calculator and comparator adds the surcharges to the commercial shipper's base rate or discounted base rate, and demonstrates the comparison of the commercial shipper's total rate to the U.S. Postal Service base rate.

The present invention claims priority to U.S. Provisional Patent Application No. 60/583,470, filed Jun. 28, 2004, the contents of which are expressly incorporated herein by reference.

### BACKGROUND OF THE INVENTION

### DESCRIPTION OF THE INVENTION

1. Field of the Invention

The present invention relates to methods and systems for calculating and comparing rates to do business, more particularly, to calculate and compare rates to ship a shipment of packages to a preselected destination, and even more particularly, to calculate and compare the rates to ship such a shipment by the U.S. Postal Service and one or more commercial shipping companies.

2. Description of the Related Art

It is well known that individuals and businesses in the United States, when they need to ship a shipment to a preselected destination, can choose as the shipper either the U.S. Postal Service or one of a plurality of commercial shipping companies, e.g., United Parcel Service (“UPS”), Federal Express (“FedEx”), DHL, and others.

It is known that shipments have a base rate to ship the packages in the shipment, based on the average weight of the package. It is further known that different destinations within the United States are collected and divided broadly into a plurality of geographic regions or shipping zones, and that each such shipping zone has a surcharge associated with it based upon ease or difficulty of delivery to an address in that shipping zone. The base rates, according to average weight of the packages and shipping zone, are typically published by the U.S. Postal Service and by each commercial shipping company. Moreover, many of the commercial shipping companies give discounted rates to selected customers.

When deciding to ship a shipment of one or more packages, either with the U.S. Postal Service or a commercial shipper, customers oftentimes compare the base rate of the U.S. Postal Service to the base rate or discounted base rate of the commercial shipper.

What is less well-known, however, when comparing rates, is that the U.S. Postal Service base rate is the same as the U.S. Postal Service total rate. This is not the case with commercial shippers. Commercial shippers typically add on a number of individual surcharges to the base rate, which the U.S. Postal Service does not do.

Customers typically are aware of a commercial shipper's base rate, or its discounted base rate, but are unaware or only generally aware of the surcharges until after reviewing the final invoice. It is desirable, therefore, as a calculation and comparison tool for customers, as a training tool for U.S. Postal Service sales personnel, and as a calculation and comparison tool for U.S. Postal Service employees, to have a method and system with which it can be quickly and easily determined, when shipping a shipment with a given number of packages, a known average package weight, and a known shipper zone, the actual cost (including base rate and applicable surcharges) to ship the same shipment via a selected commercial shipper, and via the U.S. Postal Service.

### SUMMARY OF THE INVENTION

In accordance with the invention, a system and a method are provided for calculating and comparing a rate to ship a shipment of packages to a preselected destination, by a first shipper and by a second shipper. The system and method of the invention can be used to educate customers, and to educate and train U.S. Postal Service employees, in the comparative costs to ship an identical shipment to a preselected destination in a given shipping zone. When comparing the U.S. Postal Service and a commercial shipper, the comparison includes for the U.S. Postal Service its base rate, and for the commercial shipper, both its base rate (including customer discount), plus all of the commercial shipper's often undisclosed surcharges, plus if desired costs of supplies, to obtain the actual total rate.

In accordance with one embodiment of the invention, a processor performs a method of comparing costs to ship a shipment by a plurality of shippers. The method includes the following steps: receiving background information input by the user into the processor regarding the shipment, receiving into the processor base shipping rates for a first shipper and a second shipper, determining, from data prestored in a memory, at least one surcharge from a plurality of surcharges charged by the first shipper based on the background information, adding the determined surcharge to the basic rate for the first shipper to obtain a total rate for the first shipper, and comparing the total rate for the first shipper with the base rate for the second shipper.

In accordance with the preferred embodiment, the second shipper is the U.S. Postal Service, and the first shipper is a commercial shipping company, e.g., UPS, FedEx, DHL, or the like.

Preferably, the background information input into the processor includes a number of packages in the shipment, an average weight for each package, and a destination zone corresponding to the destination for the shipment.

Preferably, the plurality of surcharges for the commercial shipper, which can be added to the commercial shipper's base rate, include an additional handling surcharge, an address correction surcharge, a tracking/tracing/refund surcharge, a C.O.D. surcharge, a signature proof of delivery surcharge, a residential delivery surcharge, a delivery area surcharge, a Saturday delivery surcharge, a return on demand surcharge, a fuel surcharge, a non-use of value account surcharge, and an on-demand pickup surcharge.

In accordance with the invention, the processor is further programmed to display, when requested by the user, individual service rate charts for each shipper, and also is programmed to provide a means for the user to visit a website for each commercial shipper.

In accordance with the invention, the processor is further programmed to calculate cost of supplies for the commercial shipper, and to add that cost to the base rate and surcharge total.

In accordance with another embodiment of the invention, a computer readable medium is provided storing program instructions for a computer to perform a method for comparing costs to ship a shipment by a plurality of shippers. The method programmed in the computer readable medium includes the following steps: receiving background information input by the user regarding the shipment, retrieving from memory base shipping rates for a first shipper and a second shipper, determining, from data prestored in a memory, at least one surcharge from a plurality of surcharges charged by the first shipper based on the background information, adding the determined surcharge to the base rate for the first shipper to obtain a total rate for the first shipper, and comparing the total rate for the first shipper with the base rate for the second shipper.

Preferably the computer readable medium is one of a hard drive, a floppy disk, an optical disk, or a web page, and the program is downloadable onto a personal computer, laptop, handheld computer, or the like.

In accordance with the invention, another embodiment includes a system for comparing shipping costs to ship a shipment by a plurality of shippers. The system includes means for inputting background information regarding the shipment, means for inputting base shipping rates for a first shipper and a second shipper, means for determining, from data prestored in a memory, at least one surcharge from a plurality of surcharges charged by the first shipper based on the background information, means for adding the determined surcharge to the base rate for the first shipper to obtain a total rate, and means for comparing the total rate for the first shipper with the base rate for the second shipper.

It is to be understood that the above general description and the following detailed description are exemplary and explanatory only and should not be considered to be restrictive of the scope of the invention, as disclosed and claimed herein. Furthermore, additional features and variations may be provided, and embodiments of the invention may be directed to various combinations and subcombinations of the features described herein.

The accompanying drawings, which are incorporated in and constitute a part of this specification, illustrate various embodiments and aspects of the invention and together with the description, serve to explain the principles of the invention.

### BRIEF DESCRIPTION OF THE DRAWINGS

FIG. 1 depicts a home screen of a shipment rate calculator and comparator in accordance with the invention;

FIG. 2 depicts an instruction screen for the calculator and comparator of the invention;

FIG. 3 depicts a screen listing function buttons published competitive shipping rates pre-stored in the calculator and comparator of the invention;

FIGS. 4A-4C depict screens in the calculator and comparator of the invention, demonstrating various shipping rates, by geographical shipping zones, for a shipment, shipped by a plurality of shippers;

FIG. 5 depicts, in the calculator and comparator of the invention, cost comparison charts for the U.S. Postal Service and one commercial shipper, including entry of a base shipping rate and customer discount, plus addition of various surcharges, plus calculation and addition of costs of supplies, in order to reach a total shipping cost; and

FIG. 6 depicts a flowchart for use of the calculator and comparator of the invention, and depicts a sequence of steps of the preferred method of the present invention.

### DETAILED DESCRIPTION OF THE EMBODIMENTS

Systems and methods consistent with embodiments of the present invention calculate and compare costs to ship a shipment by a plurality of shippers, including the U.S. Postal Service, and one of a plurality of commercial shippers, such as UPS, FedEx, and DHL Airborne.

Embodiments of the present invention are directed to a processor and to computer readable media that perform a method of calculating and comparing costs to ship a shipment by a plurality of shippers. Examples of computer readable media, consistent with embodiments of the invention include hard drives, floppy disks, optical disks, and web pages, and the programs contained therein are downloadable onto a personal computer, a laptop, a hand-held computer, and the like. The systems and methods disclosed herein are not related to any particular computer or other apparatus, and may be implemented by any suitable combination of hardware, software, and/or firmware. For example, various general purpose machines may be used with programs written in accordance with teachings of the embodiments of the invention, or it may be more convenient to construct a specialized apparatus or system to perform the required methods and techniques.

Embodiments of the invention also relate to program instructions or code for performing various computer-implemented operations based on the methods and processes of the invention. The media and program instructions may be those specifically designed and constructed for the embodiments of the invention, or they may be of the kind well-known and available to those having ordinary skill in the computer software arts. Examples of program instructions include both machine code, such as produced by a computer, and files containing a high level code that can be executed by the computer using an interpreter.

It is presently preferred that the shipping rate comparison tool of the invention be programmed on EXCEL®software, which is well-known and commercially available, and can be downloaded onto a personal computer or a laptop, but the invention is not limited to that combination of software and hardware.

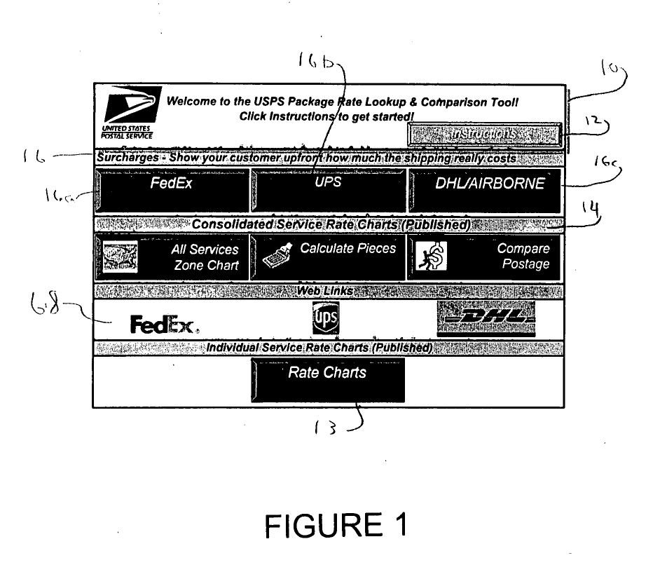

By way of introduction and example, FIG. 1 depicts a startup or home screen in a shipping rate calculator and comparator programmed with EXCEL® software, the calculator and comparator programmed to evaluate one of the commercial shippers in comparison with the U.S. Postal Service. As embodied in FIG. 1, the home screen 10 includes a variety of function buttons, which may be selected by the user to perform the shipping rate calculation and comparison.

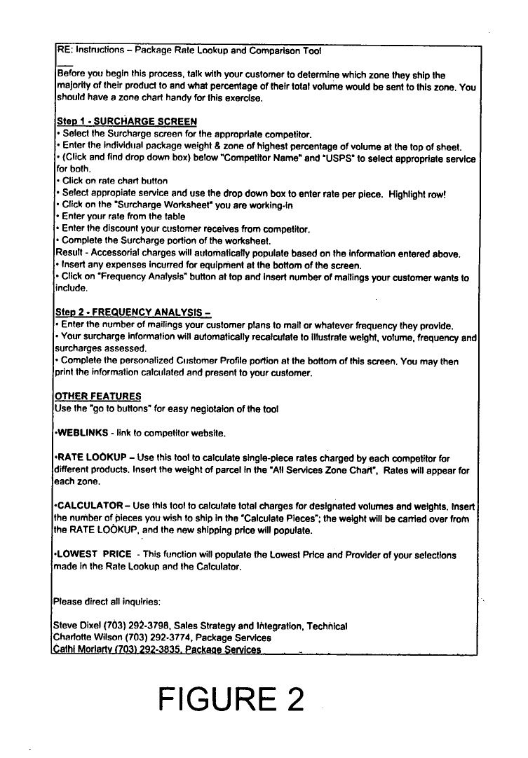

One such function button, labeled “Instructions” 12, calls up a screen substantially as depicted in FIG. 2, which provides the user clear and concise instructions for using the other functional features depicted on the home screen.

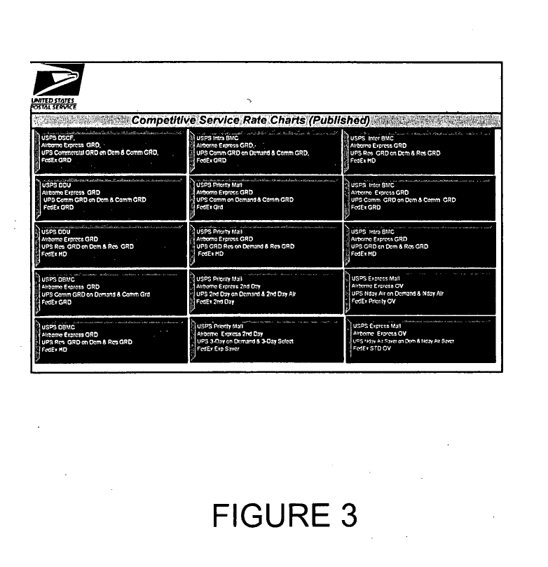

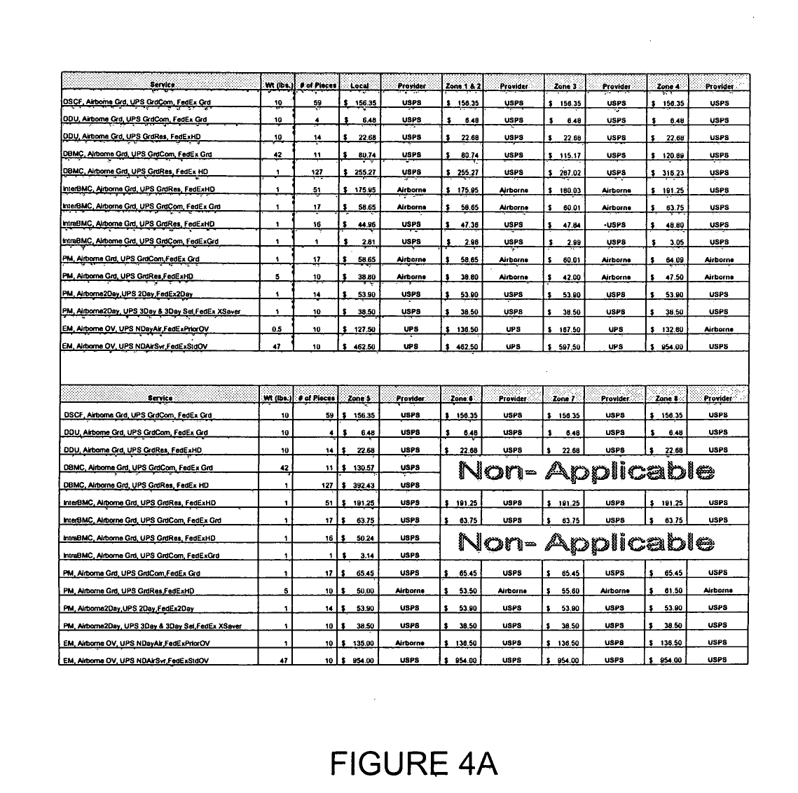

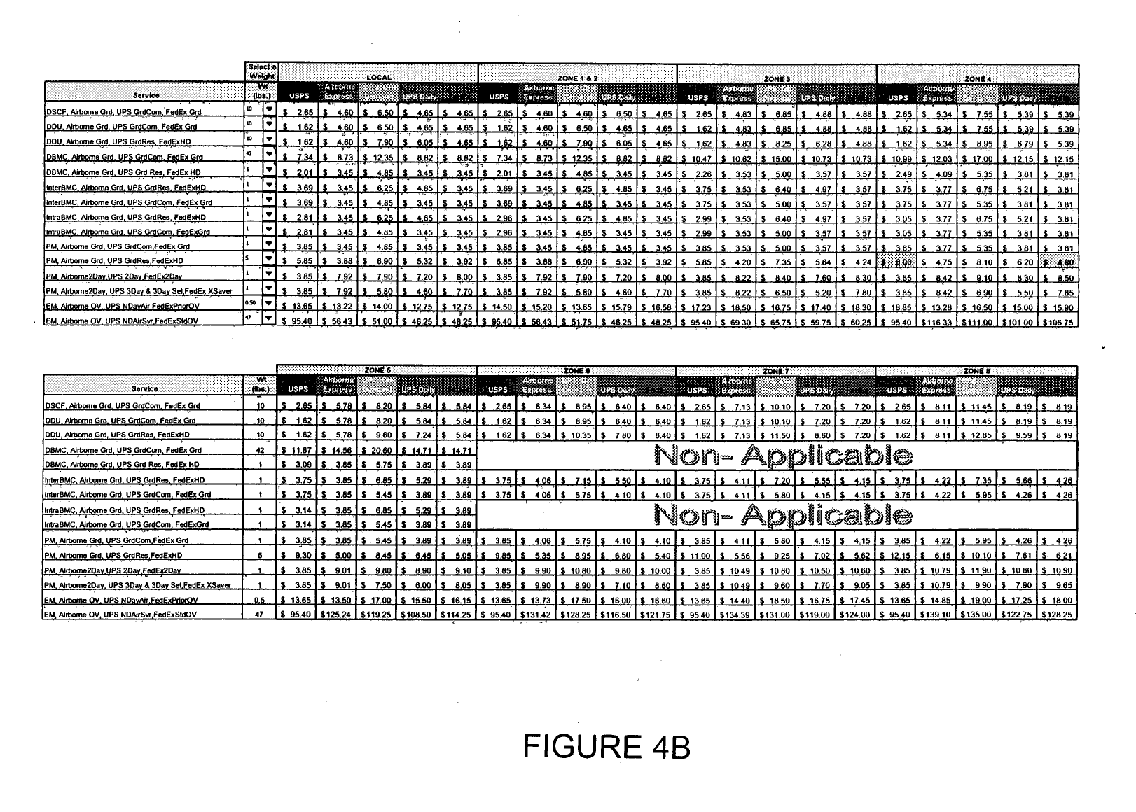

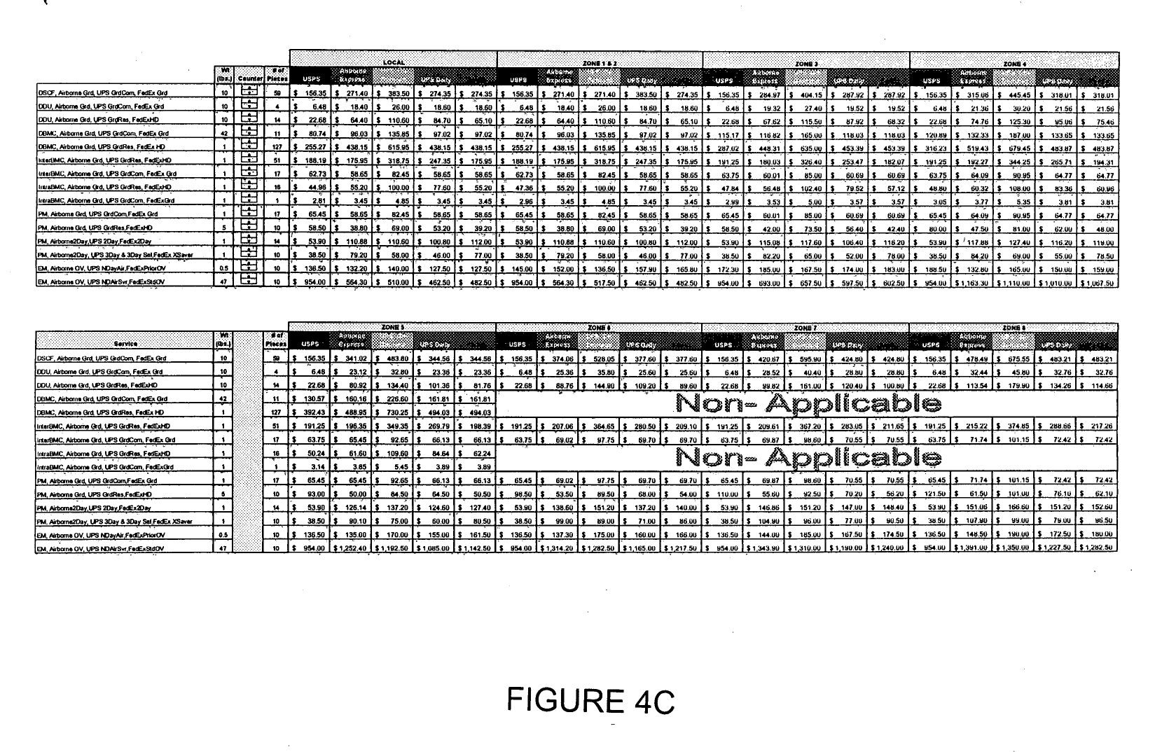

A set of function buttons, as shown for example in FIG. 3, depicting consolidated published rate charts 14, when selected, transfer the user to one of a number of charts depicting pre-programmed base rate information. Examples of these charts are depicted in FIGS. 4A-4C, displaying for the U.S. Postal Service and various commercial shippers, base rates for several selected package weights, base prices to ship to various geographical delivery zones (e.g., Zone 1, Zone 2 . . . Zone 8). Such delivery zones originally were designated for geographic areas of North America by the U.S. Postal Service, but have been adapted by most commercial shippers as well. For example, looking at the first horizontal row on FIG. 4B, it can be seen that for a single one-pound package, shipped, e.g., to a destination in Zones 1 and 2, the base rate for U.S. Postal Service to ship is $2.65. For the same package, the Airborne Express base rate, shipped to the same zone is $4.60, the UPS base rate is $6.50, and the FedEx base rate is $4.65. These base rates are published by the shippers themselves, and input into the processor before the user inputs the shipment background information.

One of ordinary skill in the shipping art will recognize that for the U.S. Postal Service, the base rate is also the total rate, but that for the commercial companies, additional costs or “surcharges” must be added to the base rate in order to obtain the total rate. These surcharges often are not disclosed at all, or are only partially disclosed, to a customer. The customer sees the total cost only when it receives the final invoice for the shipment.

Returning to home page 10 in FIG. 1, the user may select one of the shipping cost buttons 16a, 16b and 16c. Pressing one of these buttons transfers the user to the surcharge and total rate calculation screen for the selected commercial shipper, where the customer can calculate the total cost to ship the shipment by the commercial shipper, and compare the total cost to the U.S. Postal Service base cost for the same shipment.

As depicted in FIG. 1, a separate shipping cost button 16 is provided for each commercial shipper, e.g., Federal Express (“FedEx”) 16a, United Parcel Service (“UPS”) 16b, and DHL/Airborne 16c, but the invention is not limited to these commercial shippers.

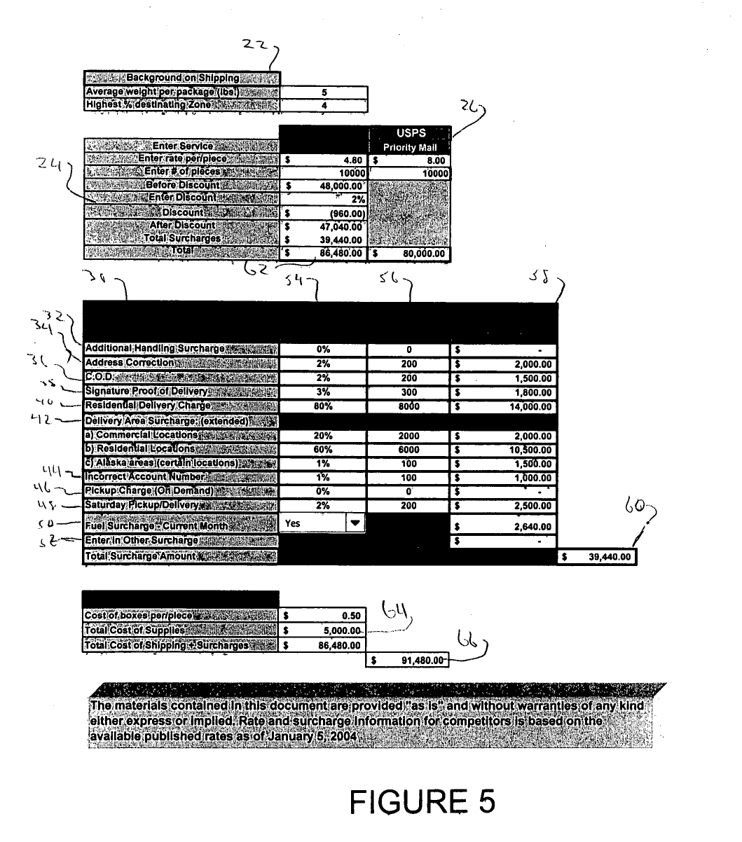

Selection of one of the shipping cost buttons 16, transfers the user to a cost calculator screen 20, depicted in FIGS. 5a-5b.

On a first screen 20a, as shown in FIG. 5, the user enters background information 22 regarding the shipment, including, for example, the number of packages included in the shipment, an average weight per package, and the highest destination zone to which the shipment is to be shipped. Preferably, as screen 20b, the user also can input his known customer discount 24. With the pre-programmed base rate, the user can first see and compare the base rate for the U.S. Postal Service 26 to ship the selected number of packages to the given destination, and simultaneously the base rate or discounted base rate for the selected commercial shipper 28, e.g., DHL/Airborne, UPS, or FedEx.

As further embodied in FIG. 5, the system calculates and displays the additional surcharges 30, which typically are undisclosed by these commercial shippers. As embodied in FIG. 5, typical surcharges may include, e.g., an additional handling surcharge 32, an address correction surcharge 34, a C.O.D. surcharge 36, a signature proof of delivery surcharge 38, a residential delivery surcharge 40, an extended delivery area surcharge 42, an incorrect account number surcharge 44, an on-demand pickup fee surcharge 46, a Saturday delivery/pickup surcharge 48, a fuel surcharge 50, and a “catchall” other surcharge 52. Although these surcharges are known and contemplated at this time, the invention is not limited to displaying these surcharges. As further embodied in FIG. 5, the surcharge calculator includes three displays: the surcharge percent 54, input from preprogrammed data, the number of packages in the shipment 56, input by the user, a total for each individual surcharge 58, calculated by the calculator and comparator, and a total of the various surcharges 60, summed by the calculator and entered automatically. A total shipping rate 62 of base cost plus surcharges for the commercial shipper is calculated and displayed adjacent the U.S. Postal Service base rate, for comparison by the user. As a final step, the commercial shipper's cost of supplies 64 can be calculated and displayed, along with a total cost 66 for the commercial shipper of base rate plus surcharges plus cost of supplies.

Referring to FIG. 5, for example, in accordance with the invention, for a 10,000 package shipment with an average weight of a five pounds per package being shipped to Zone 4, the total surcharges for FedEx equal $39,440, which when added onto the discounted base rate of $47,040, make the cost to ship to the destination via FedEx $86,480, which is $6,480 more expensive than shipping the same package with U.S. Postal Service, because U.S. Postal Service has only its base rate, which for the same shipment is $80,000. Because U.S. Postal Service does not add on surcharges, as does the commercial shipper, the U.S. Postal Service total cost is lower, as can be clearly seen and understood both by a U.S. Postal Service employee and a customer when using the invention.

This comparison can be used to educate any user, both a paying customer, and a U.S. Postal Service employee, for example, demonstrating in detail how shipping with U.S. Postal Service compares with shipping with one or more commercial shippers.

In accordance with the invention, the home page 10 further includes web link buttons 68, capable of transferring the user to respective websites for each of the commercial shippers that are being compared to U.S. Postal Service.

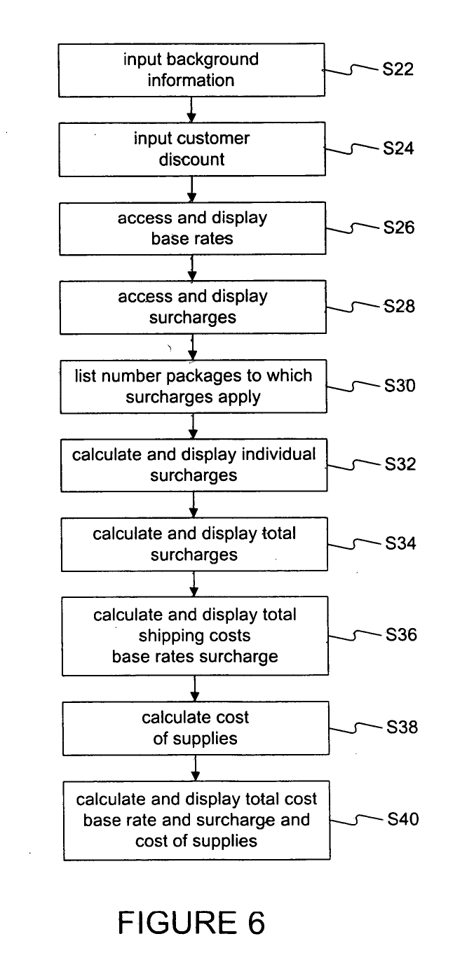

The cost calculation and comparison method described above, programmed into computer-readable media, and performed by a processor, can be understood with reference to the flow chart depicted in FIG. 6. At step S22, the user inputs background information on the shipment, e.g., number of packages, average weight per package, and destination shipping zone. At step S24, the user also inputs its customer discount (if any) it receives from the commercial shipper. At step S26, the system accesses and displays, for a shipment having the input background information, pre-stored base shipping rate information for the U.S. Postal Service and the base rate for the shipper. At step S28, the system accesses and displays all of the pre-stored rates for all of the applicable surcharges the commercial shipper will apply to this shipment. At step S30, the system lists the number of packages (from background information) to which the surcharges apply. At step S32, the system calculates and displays each individual surcharge. At step S34, the system calculates and displays the total surcharges. At step S36, the system calculates and displays the total shipping cost (base rate plus surcharges) for the commercial shipper, displaying it, for comparison, alongside the base shipping rate for the U.S. Postal Service. At step S38, the system calculates the commercial shipper's cost of supplies, and at S40 displays the commercial shipper's total cost of base rate plus surcharges plus cost of supplies.

Modification to the above-disclosed embodiments will be apparent to those skilled in the art from consideration and practice of the invention disclosed herein. For example, one skilled in the art will appreciate that the disclosed systems and methods may be distributed over various components and/or over various computers. Additionally, the information presented in the customer or U.S. Postal Service employee may be entirely through a computer-readable medium, or in combination with other sources or materials, such as web page, or printed materials. Furthermore, the disclosed methods may be modified to alter the order of the steps or add or delete steps.

It is intended, therefore, that the specification and disclosed embodiments be considered as exemplary, with the scope and spirit of the invention being indicated by the literal equivalent scope of the following claims.

1. A method, performed by a processor, of comparing costs to ship a shipment by a plurality of shippers, comprising:
inputting background information regarding the shipment;
inputting basic shipping rates for a first shipper and a second shipper;
determining, from data prestored in a memory, at least one surcharge charged by the first shipper, based on the background information;
adding the determined surcharge to the basic rate for the first shipper to obtain a total rate for the first shipper; and
comparing the total rate for the first shipper with the basic rate for the second shipper.

2. The method of claim 1, wherein the background information comprises a number of packages included in the shipment.

3. The method of claim 2, wherein the background information comprises an average weight for each package in the shipment.

4. The method of claim 1, wherein the background information includes a destination zone where the shipment is to be shipped.

5. The method of claim 1, wherein the second shipper is the U.S. Postal Service.

6. The method of claim 5, wherein the first shipper is a commercial shipping company.

7. The method of claim 1, wherein the at least one surcharge is a surcharge selected from the group consisting of additional handling surcharge, address correction surcharge, tracking/tracing/refund surcharge, C.O.D. surcharge, signature proof of delivery surcharge, residential delivery surcharge, delivery area surcharge, Saturday delivery surcharge, return on demand surcharge, fuel surcharge, non-use of value account number surcharge, and on-demand pickup surcharge.

8. The method of claim 1, further comprising displaying individual service rate charts for the first shipper and the second shipper.

9. The method of claim 6, further comprising selecting and viewing a website for the commercial shipping company.

10. The method of claim 1, further comprising calculating a cost of supplies for the shipment.

11. The method of claim 10, further comprising calculating and displaying a total cost equal to base rate plus surcharges plus cost of supplies.

12. A computer readable medium storing program instructions for a computer to perform a method of comparing costs to ship a shipment by a plurality of shippers, the method comprising:
inputting background information regarding the shipment;
inputting basic shipping rates for a first shipper and a second shipper;
determining, from data prestored in a memory, at least one surcharge charged by the first shipper, based on the background information;
adding the determined surcharge to the basic rate for the first shipper to obtain a total rate for the first shipper; and
comparing the total rate for the first shipper with the basic rate for the second shipper.

13. The computer readable medium of claim 12, wherein the computer readable medium comprises a hard drive.

14. The computer readable medium of claim 12, wherein the computer readable medium comprises a floppy disk.

15. The computer readable medium of claim 12, wherein the computer readable medium comprises an optical disk.

16. The computer readable medium of claim 12, wherein the computer readable medium comprises a web page and the program is downloadable onto a computer.

17. The computer readable medium of claim 12, wherein the program is downloadable onto a laptop computer.

18. The computer readable medium of claim 12, wherein the background information comprises a number of packages included in the shipment.

19. The computer readable medium of claim 12, wherein the background information comprises an average weight for each package in the shipment.

20. The computer readable medium of claim 12, wherein the background information includes a destination zone where the shipment is to be shipped.

21. The computer readable medium of claim 12, wherein the second shipper is the U.S. Postal Service.

22. The computer readable medium of claim 21, wherein the first shipper is a commercial shipping company.

23. The computer readable medium of claim 12, wherein the at least one surcharge is a surcharge selected from the group consisting of additional handling surcharge, address correction surcharge, tracking/tracing/refund surcharge, C.O.D. surcharge, signature proof of delivery surcharge, residential delivery surcharge, delivery area surcharge, Saturday delivery surcharge, return on demand surcharge, fuel surcharge, non-use of value account number surcharge, and on-demand pickup surcharge.

24. The computer readable medium of claim 12, further comprising displaying individual service rate charts for the first shipper and the second shipper.

25. The computer readable medium of claim 12, further comprising selecting and viewing a website for the commercial shipping company.

26. A method for training an individual concerning comparable costs between shippers to ship a shipment, comprising:
inputting background information regarding the shipment;
inputting basic shipping rates for a first shipper and a second shipper;
determining, from data prestored in a memory, at least one surcharge charged by the first shipper, based on the background information;
adding the determined surcharge to the basic rate for the first shipper to obtain a total rate; and
comparing the total rate for the first shipper with the basic rate for the second shipper.

27. The method of claim 26, wherein the background information comprises a number of packages included in the shipment.

28. The method of claim 27, wherein the background information comprises an average weight for each package in the shipment.

29. The method of claim 26, wherein the background information includes a destination zone where the shipment is to be shipped.

30. The method of claim 26, wherein the second shipper is the U.S. Postal Service.

31. The method of claim 30, wherein the first shipper is a commercial shipping company.

32. The method of claim 26, wherein the at least one surcharge is a surcharge selected from the group consisting of additional handling surcharge, address correction surcharge, tracking/tracing/refund surcharge, C.O.D. surcharge, signature proof of delivery surcharge, residential delivery surcharge, delivery area surcharge, Saturday delivery surcharge, return on demand surcharge, fuel surcharge, non-use of value account number surcharge, and on-demand pickup surcharge.

33. The method of claim 26, further comprising displaying individual service rate charts for the first shipper and the second shipper.

34. The method of claim 31, further comprising selecting and viewing a website for the commercial shipping company.

35. A system for comparing costs to ship a shipment by a plurality of shippers, comprising:
means for inputting background information regarding the shipment;
means for inputting basic shipping rates for a first shipper and a second shipper;
means for determining, from data prestored in a memory, at least one surcharge charged by the first shipper, based on the background information;
means for adding the determined surcharge to the basic rate for the first shipper to obtain a total rate; and
means for comparing the total rate for the first shipper with the basic rate for the second shipper.

36. The system of claim 35, wherein the background information comprises a number of packages included in the shipment.

37. The system of claim 35, wherein the background information comprises an average weight for each package in the shipment.

38. The system of claim 35, wherein the background information includes a destination zone where the shipment is to be shipped.

39. The system of claim 35, wherein the second shipper is the U.S. Postal Service.

40. The system of claim 35, wherein the first shipper is a commercial shipping company.

41. The system of claim 35, wherein the at least one surcharge is a surcharge selected from the group consisting of additional handling surcharge, address correction surcharge, tracking/tracing/refund surcharge, C.O.D. surcharge, signature proof of delivery surcharge, residential delivery surcharge, delivery area surcharge, Saturday delivery surcharge, return on demand surcharge, fuel surcharge, non-use of value account number surcharge, and on-demand pickup surcharge.

42. The system of claim 35, further comprising displaying individual service rate charts for the first shipper and the second shipper.

43. The system of claim 41, further comprising selecting and viewing a website for the commercial shipping company.

44. The system of claim 35, further comprising inputting a customer standard discount with the base shipping rate.

45. The computer readable medium of claim 12, wherein the instructions further instruct the computer to consider a standard customer discount with the base shipping rate.

46. The method of claim 26, further comprising selecting and viewing a website for the commercial shipping company.

47. The system of claim 35, further comprising means for inputting a customer standard discount with the base shipping rate.
